(19) United States
(12) Patent Application Publication
(10) Pub. No.: US 2013/0114807 A1
(43) Pub. Date: May 9, 2013

(54) INFORMATION SHARING METHOD AND MODULE, DEVICE AND ELECTRONIC PRODUCT USING THE SAME

(71) Applicants: Liang-Gee CHEN, Taipei (TW); Tien-Ju YANG, Taipei (TW); Yi-Min TSAI, Taipei (TW)

(72) Inventors: Liang-Gee CHEN, Taipei (TW); Tien-Ju YANG, Taipei (TW); Yi-Min TSAI, Taipei (TW)

(73) Assignee: National Taiwan University, Taipei (TW)

(21) Appl. No.: 13/368,432

(22) Filed: Feb. 8, 2012

(30) Foreign Application Priority Data
Nov. 7, 2011 (TW) 100140602

(51) Int. Cl. H04L 9/12

(52) U.S. Cl. 380/43

(57) ABSTRACT

An exemplary information sharing method is provided. The information sharing method includes a step of: broadcasting predetermined sharing information to a user terminal(s) within a preset region on a client side in response to a sharing request while an information sharing function is enable. An information sharing module, device and electronic apparatus using the same are also provided.

### TECHNICAL FIELD

The present invention relates to an information sharing method, and more particularly to an information sharing method for sharing a photo file.

### BACKGROUND

In people's daily life, digital cameras have become a very popular electronic device. Today, with the advance of the optical technology digital cameras can have a much higher resolution and also can be integrated with various electronic devices, such as a mobile phone, a smart phone, a tablet computer, etc. Therefore, more and more people use digital cameras to record their daily lives.

Generally, if a group of people want to take a group photo and each one of them would like to have the group photo, one of them needs to collect all the digital cameras from the group of people and uses these collected digital cameras one by one to take photos of the group of people.

However, this shooting process is not only disturbing but also time-consuming. Because the shooting process is so disturbing and time-consuming, finally people in the group may feel impatient and have stiff faces, and thereby resulting in the photos having a poor quality. To avoid the above situation, the group of people may use one digital camera to shoot a photo of the group of people, and then share the group photo to each other through uploading the group photo to Internet. However, the one who has the group photo may forget to upload the group photo to Internet or the rest members may forget to download the group photo. As a result, the group of people may regret not completely having all the photos.

To solve the above problems, the group of people can firstly establish a connection, such as a Bluetooth or infrared connection, between each two individual digital cameras and then share the group photo therebetween. However, the establishment of the connection may waste a lot of resource and the establishing connection process is still time-consuming. In addition, the above-described photo sharing way is only adaptive for one-to-one sharing; in other words, it is a huge work to complete photo sharing among the all digital cameras.

### SUMMARY OF EMBODIMENTS

Therefore, one object of the present invention is to provide an information sharing method for real-time sharing a latest shot photo to a group of people.

Another object of the present invention is to provide an information sharing module, device and electronic apparatus capable of sharing a latest shot photo to a group of people without the need of a specific connection establishment or network therebetween.

The present invention provides an information sharing method, which includes a step of: broadcasting first predetermined sharing information to a user terminal(s) within a first preset region on a client side in response to a sharing request while an information sharing function is enable.

In an embodiment of the present invention, before the broadcast of the first predetermined sharing information, the information sharing method further includes a step of: encrypting the first predetermined sharing information.

In an embodiment of the present invention, the information sharing method further includes steps of: generating first Key data when a Key sharing function is enable; and broadcasting the first Key data to a user terminal(s) within a second preset region on the client side. The encrypted first predetermined sharing information is decrypted by the first Key data.

In an embodiment of the present invention, the first preset region is larger than the second preset region.

In an embodiment of the present invention, the first and second predetermined sharing information each are a latest shot photo or video.

The present invention still provides an information sharing module, which includes an antenna unit, a transceiver module and a processing module. The transceiver module is coupled to the antenna unit. The processing module is coupled to the transceiver module for transmitting first predetermined sharing information to the transceiver module in response to a sharing request while an information sharing function is enable, and controlling the transceiver module through the antenna unit to broadcast the first predetermined sharing information to a user terminal(s) within a preset region on a client side without the need of a specific connection establishment or network therebetween.

The present invention still provides an information sharing device adapted to be externally installed to an electronic apparatus. The information sharing device includes an antenna unit, a transceiver module, a connection module and a processing module. The transceiver module is coupled to the antenna unit. The connection module has a connection unit for coupling to the electronic apparatus. The processing module is coupled to the transceiver module and the connection module for retrieving first predetermined sharing information from the electronic apparatus in response to a sharing request while an information sharing function is enable and then transmitting the first predetermined sharing information to the transceiver module. The transceiver module through the antenna unit broadcasts the first predetermined sharing information to a user terminal(s) within a preset region on a client side.

In an embodiment of the present invention, the information sharing device further includes a power supply module. The power supply module is coupled to the connection module for receiving direct-current power from the electronic apparatus, converting the received direct-current power into operating power, and supplying the operating power to the information sharing device for use.

The present invention still provides an electronic product, which includes a control circuit and an information sharing module. The control circuit is for retrieving first predetermined sharing information from, for example, a storage unit thereof or other units/or components outside the control circuit. The information sharing module is coupled to the control circuit for broadcasting the retrieved first predetermined sharing information to a user terminal(s) within a preset region on a client side in response to a sharing request when an information sharing function is enable.

In an embodiment of the present invention, the electronic product further includes a Key enable unit. The Key sharing function is enable when the Key enable unit is triggered.

In an embodiment of the present invention, the electronic product further includes a transmission enable unit. The information sharing function is enable when the transmission enable unit is triggered.

Therefore, through simply arranging an electronic apparatus installed with the information sharing module within a preset region, in response to a sharing request while an information sharing function is enable, the latest shot photo or video of the electronic apparatus can be shared in real time to a user terminal(s) in the preset region without the need of a specific connection establishment and network therebetween.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic block view of an information sharing module in accordance with an embodiment of the present invention;

FIG. 2 is a schematic block view of an internal structure of a processing module in accordance with an embodiment of the present invention;

FIG. 3 is a schematic block view of an electronic product in accordance with an embodiment of the present invention;

FIG. 4 is a schematic view of the electronic product of FIG. 3 in a form of a memory card;

FIG. 5 is a schematic view illustrating a connection relationship between an information sharing device in accordance with an embodiment of the present invention and an electronic apparatus;

FIG. 6 is a schematic block view of an information sharing device in accordance with an embodiment of the present invention; and

FIGS. 7A, 7B are schematic flow charts of an information sharing method in accordance with an embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

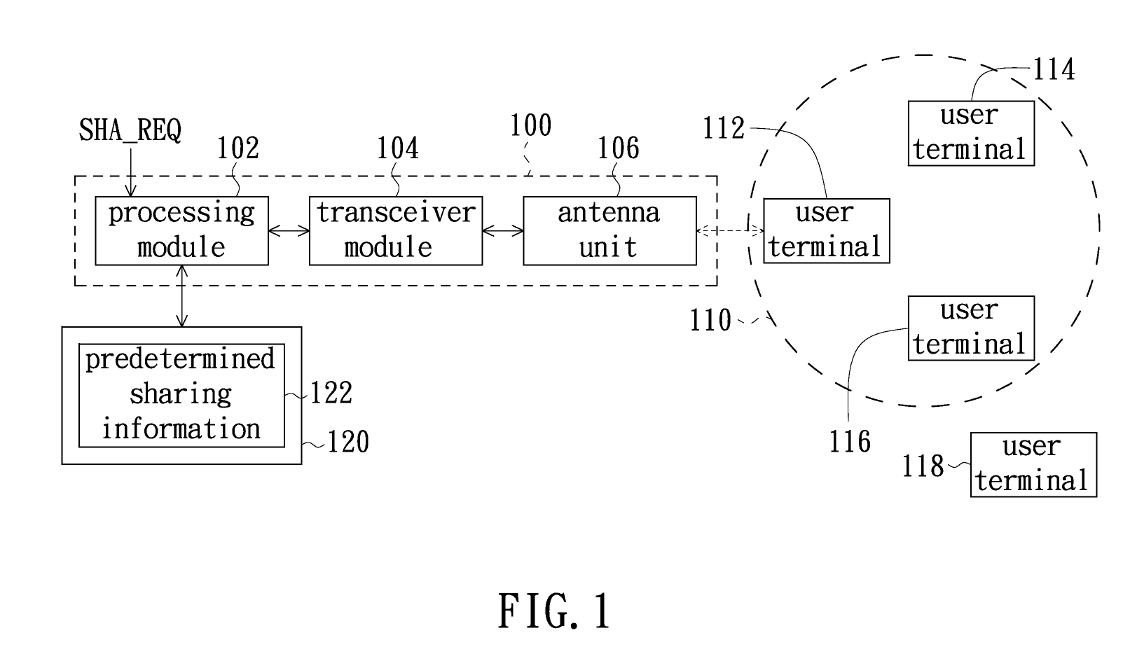

FIG. 1 is a schematic block view of an information sharing module in accordance with an embodiment of the present invention. As shown in FIG. 1, the information sharing module 100 of the present embodiment is adapted to manage predetermined sharing information 122, which is, for example, referred to as a photo or a video latest shot by an electronic product where the information sharing module 100 is installed. The information sharing module 100 includes a processing module 102, a transceiver module 104 and an antenna unit 106; wherein the transceiver module 104 is coupled between the processing module 102 and the antenna unit 106.

In a view of a host side, the processing module 102 is configured to retrieve the predetermined sharing information 122 from a storage space 120 in response to a sharing request SHA_REQ while an information sharing function is enable. The retrieved predetermined sharing information 122 is then transmitted to the transceiver module 104 and through the antenna unit 106 is further broadcasted to a user terminal(s) within a preset region 110, such as the user terminals 112, 114 and 116. It is to be noted that the transmission of the predetermined sharing information 122 between the information sharing module 100 and the user terminals 112, 114 and 116 is realized by a broadcasting manner, so there is no need to establish any specific connection or network therebetween before the transmission of the predetermined sharing information 122. In the present embodiment, the user terminals 112, 114 and 116 can be, for example, memory cards, mobile hard drives, digital cameras, smart handheld devices, etc. In addition, the sharing request SHA_REQ is issued from the electronic product where the information sharing module 100 is installed. Besides, the user terminals out of the preset region 110, such as the user terminal 118, will not receive the predetermined sharing information 122 while the broadcasting action is in progress.

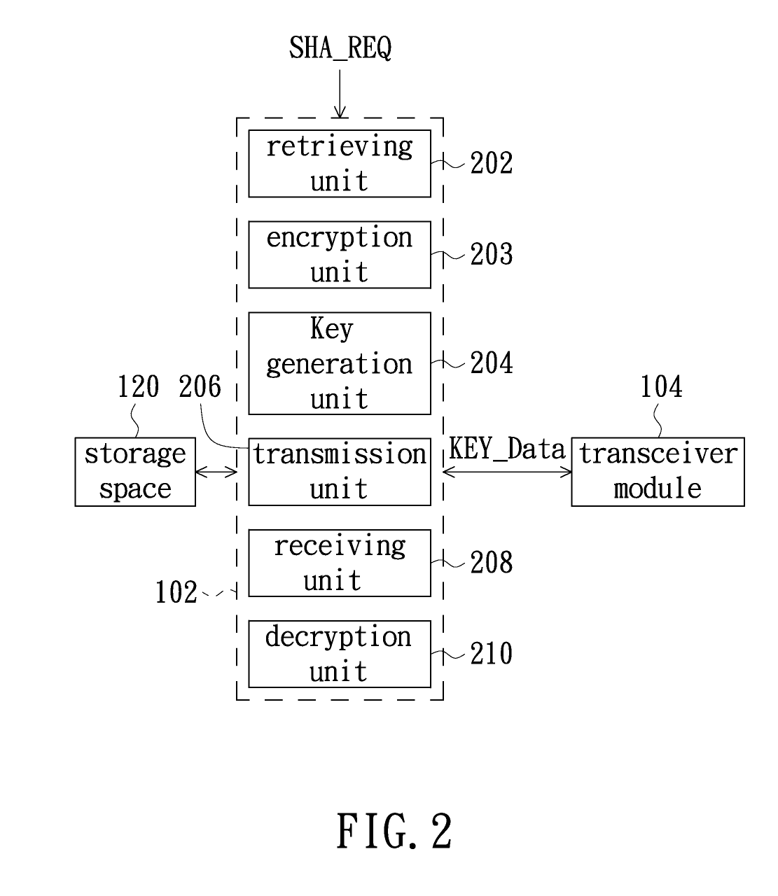

FIG. 2 is a schematic block view of an internal structure of the processing module 102 in accordance with an embodiment of the present invention. Please refer to FIGS. 1 and 2 and in a view of a host side, the processing module 102 primarily includes a retrieving unit 202, a transmission unit 206 and a receiving unit 208. In another embodiment, the processing module 102 may further include an encryption unit 203, a Key generation unit 204 and a decryption unit 210. The Key generation unit 204 is configured to generate Key data KEY_Data in response to an enablement of a Key sharing function. The Key data KEY_Data is then transmitted to the transceiver module 104 by the transmission unit 206 and through the antenna unit 106 is further broadcasted to a user terminal(s) within the preset region 110, such as the user terminals 112, 114 and 116, without the need of any specific connection establishment or network therebetween.

The retrieving unit 202 is configured to retrieve the predetermined sharing information 122 from the storage space 120 once the processing module 102 receives the sharing request SHA_REQ while the information sharing function is enable. The retrieved predetermined sharing information 122 is then encrypted by the encryption unit 203. The encrypted predetermined sharing information 122 is then transmitted to the transceiver module 104 by the transmission unit 206 and through the antenna unit 106 is further broadcasted to a user terminal(s) within the preset region 110, such as the user terminals 112, 114 and 116, without the need of any specific connection establishment or network therebetween.

Alternatively, in a view of a client side, when the Key data KEY_Data is transmitted to the information sharing module 100 from one of the user terminals 112, 114 and 116 through the above-described transmission mechanism, firstly the Key data KEY_Data is transmitted to the transceiver module 104 through the antenna unit 106 and then further transmitted to the processing module 102. In the present embodiment, the Key data KEY_Data is then stored in the storage space 120 by the processing module 102.

Afterwards, when the encrypted predetermined sharing information 122 is transmitted to the information sharing module 100 from one of the user terminals 112, 114 and 116 through the above-described transmission mechanism, firstly the encrypted predetermined sharing information 122 is transmitted to the transceiver module 104 through the antenna units 106 and then further transmitted to the processing module 102, specifically, the receiving unit 208 of the processing module 102. Afterwards, the Key data KEY_Data is retrieved by the decryption unit 210 from the storage space 120, and the encrypted predetermined sharing information 122 is decrypted by the decryption unit 210 according to the retrieved Key data KEY_Data so as to be restored back to the predetermined sharing information 122.

Some exemplary applications of the information sharing module 100 of the present invention will be illustrated in the following.

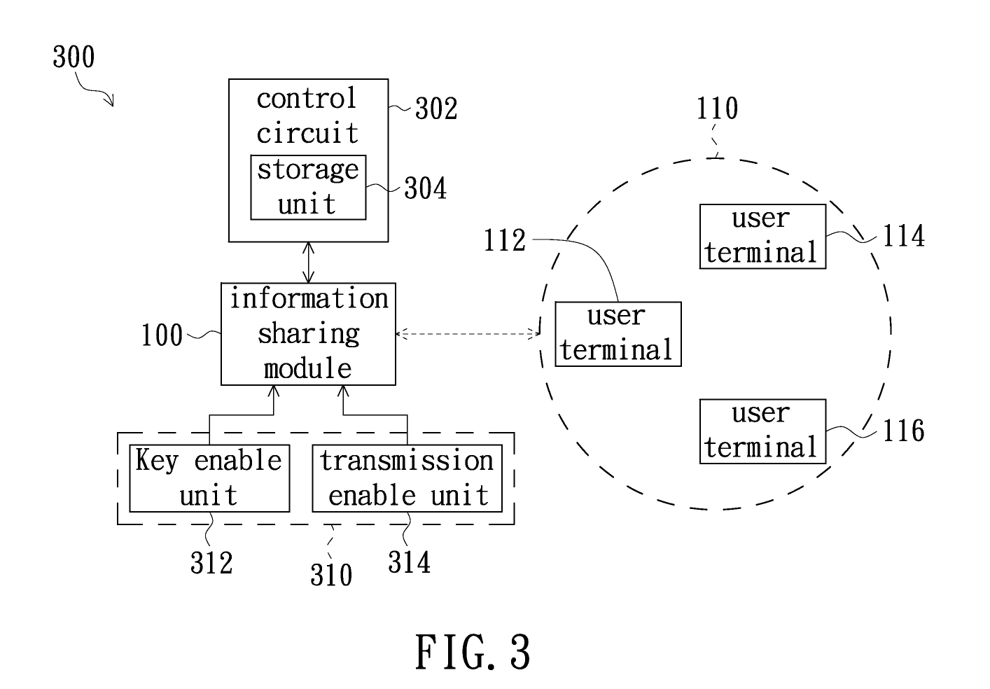

FIG. 3 is a schematic block view of an electronic product in accordance with an embodiment of the present invention. Please refer to FIGS. 1 and 3, the electronic product 300 of the present embodiment is installed with the information sharing module 100 and can be, for example, a digital camera, a smart phone, a tablet PC, a memory card, a flash drive, etc. The electronic product 300 further includes a control circuit 302 coupled to the information sharing module 100. As described above, in a view of a host side, when the Key sharing function is enable, firstly the Key data KEY_Data is generated by the information sharing module 100 and then broadcasted to a user terminal(s) within the preset region 110, such as the user terminals 112, 114 and 116. Afterwards, when the information sharing function is enable and the information sharing module 100 receives the sharing request SHA_REQ, the control circuit 302 retrieves the predetermined sharing information 122 and then transmits the predetermined sharing information 122 to the information sharing module 100. And similarly, the predetermined sharing information 122 is broadcasted to a user terminal(s) within the preset region 110, such as the user terminals 112, 114 and 116 according to the above-described transmission mechanism.

In another embodiment, the predetermined sharing information 122 may be stored out of the electronic product 300 and accordingly the control circuit 302 is capable of retrieving the predetermined sharing information 122 from external of the electronic product 300. In still another embodiment, the control circuit 302 may include an internal storage unit 304, such as a flash memory, functioned like the storage space 120 in FIG. 1; and thus, the predetermined sharing information 122 can be stored in the storage unit 304.

In addition, the sharing request SHA_REQ can be generated by some specific predetermined operations on the electronic product 300. For example, if the electronics 300 is a digital camera, the sharing request SHA_REQ is generated and issued to the information sharing module 100 when the shutter of the electronics 300 is pressed while the information sharing function is enabled. And thus, the latest shot photo or video is referred to as the predetermined sharing information 122 and is broadcasted to a user terminal(s) within the preset region 110. Alternatively, in a view of a client side, the latest shot photo or video (the predetermined sharing information 122) is stored in the storage unit 304 when it is transmitted to the information sharing module 100 from a user terminal(s) within the preset region 110, such as the user terminals 112, 114 and 116.

In the above embodiments, the Key data KEY_Data and the predetermined sharing information 122 both are broadcasted to the same preset region 110; however, in a practical situation, the preset region corresponding to the Key data KEY_Data may differ to the preset region corresponding to the predetermined sharing information 122. In particular, the preset region corresponding to the Key data KEY_Data is smaller than the preset region corresponding to the predetermined sharing information 122; and thus, only the user terminal(s) restricted in a smaller region can have the Key data KEY_Data and the user terminal(s) with the Key data KEY_Data can have a movement liberty while receiving the predetermined sharing information 122.

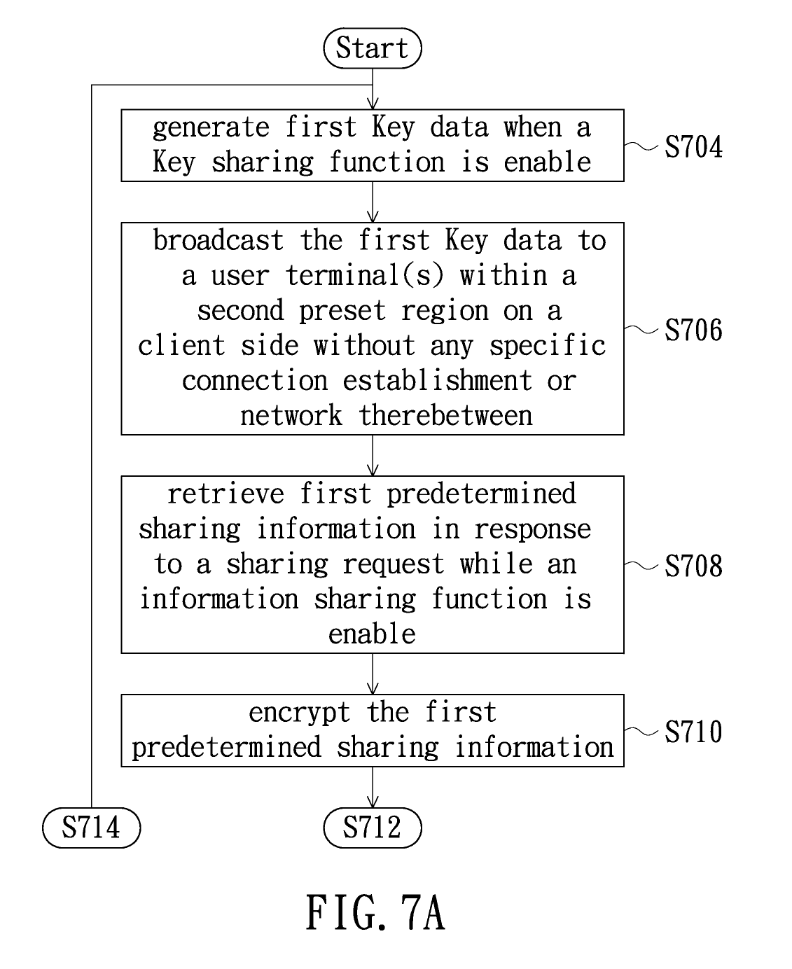

In another embodiment, the information sharing module 100 can be further provided with a register, like the register 608 shown in FIG. 6. The information sharing module 100 can temperately store the received Key data KEY_Data in the register while waiting for the execution of the decryption on the encrypted predetermined sharing information 122.

In the present embodiment, the electronics product 300 can be further provided with an operation module 310. The operation module 310 includes a Key enable unit 312 and a transmission enable unit 314, and each can be, for example, realized by a physical button, a toggle switch, a touch panel, a wheel mouse, a joystick, etc. In the present embodiment, the Key sharing function and the information sharing function are enable if the Key enable unit 312 and the transmission enable unit 314 are triggered, respectively.

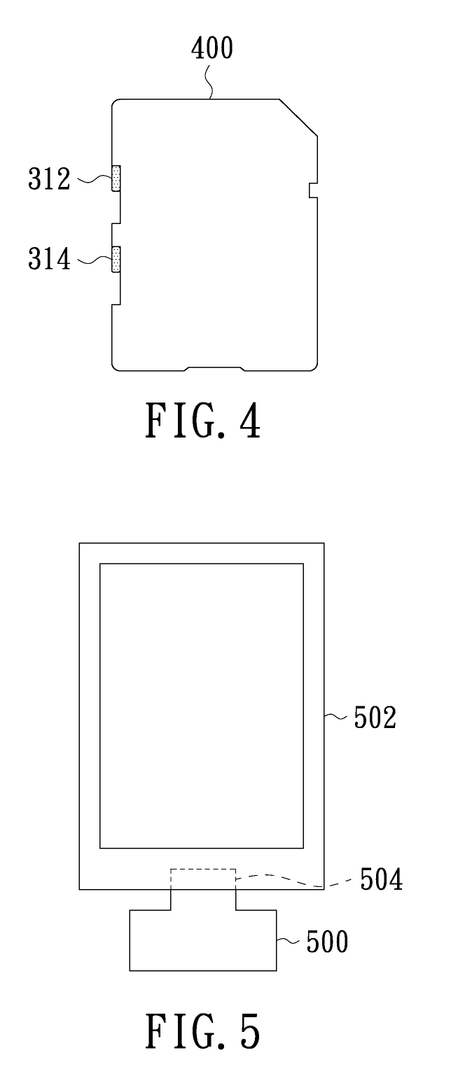

The electronic product 300 can be presented in a form of various devices. FIG. 4 is a schematic view of the electronic product 300 in a form of a memory card. As shown in FIG. 4, the Key enable unit 312 and the transmission enable unit 314 are implemented by two toggle switches of the memory card 400. Specifically, the Key sharing function is enable when the toggle switch in the memory card 400 corresponding to the Key enable unit 312 is toggled; and the information sharing function is enable when the toggle switch in the memory card 400 corresponding to the transmission enable unit 314 is toggled. In the present embodiment, if the memory card 400 is inserted into an electronic apparatus (such as a digital camera, a tablet computer or a smart phone) and the information sharing function thereof is enable, the memory card 400 is configured to retrieve the predetermined sharing information therein or from the connected electronic apparatus and then further broadcast the retrieved predetermined sharing information based on the above-described sharing mechanism in response to the sharing request SHA_REQ, which is issued from an electronic apparatus the memory card 400 is electrically connected to.

So, the above-described sharing mechanism can be realized in the memory card 400 of the present embodiment without complicated operations on the electronic apparatus where the memory card 400 is inserted. In addition, the chip design in the memory card 400 can have a downward compatibility manner; and thus, the memory card 400 can be applied to most handheld devices in market.

Therefore, without the complicated password setting, a user can easily have the electronic product 300 to realize the broadcast of the Key data and the predetermined sharing information by simply triggering corresponding switches thereof. And thus, the present invention can have an advantage of easy operation.

In another embodiment, the electronic product 300 can be in a form of a flash drive and thus the related transmission functions in the processing module 102 can be turned off. Accordingly, the flash drive is configured to receive and store the latest shot photo or video from the user terminal on the host side only.

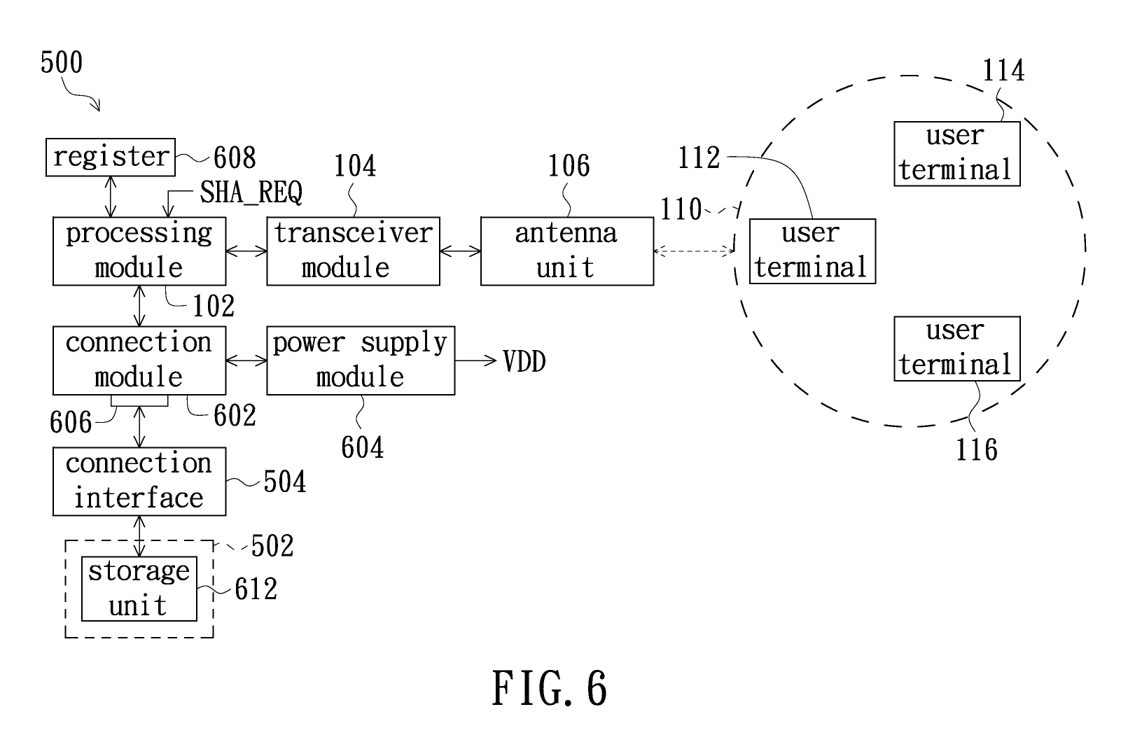

FIG. 5 is a schematic view illustrating a connection relationship between an information sharing device in accordance with an embodiment of the present invention and an electronic apparatus. As shown in FIG. 5, the information sharing device 500 of the present embodiment includes a connection interface 504, e.g., a universal serial bus (USB) interface or other types of interfaces; and through the connection interface 504 the information sharing device 500 is connected to the electronic apparatus 502. Specifically, the electronic apparatus 502 is, for example, a smart phone or a tablet computer, and includes a storage unit similar to the storage unit 612 in FIG. 6; and the information sharing device 500 is installed with the information sharing module 100.

FIG. 6 is a schematic block view of the information sharing device 500 in accordance with an embodiment of the present invention. As shown in FIG. 6, except of the processing module 102, the transceiver module 104 and the antenna unit 106 of the information sharing module 100 and the connection interface 504, the information sharing device 500 further includes a connection module 602 and a power supply module 604. The connection module 602 includes a connection unit 606 coupled to the connection interface 504.

Similarly, in the view of a host side, the processing module 102 firstly generates first Key data KEY_Data in response to an enablement of a Key sharing function and then controls the transceiver module 104 through the antenna unit 106 to broadcast the first Key data KEY_Data to a user terminal(s) within a preset region 110, such as the user terminals 112, 114 and 116, without the need of any specific connection establishment or network therebetween. The processing module 102 then retrieves first predetermined sharing information from the electronic apparatus 502 through the connection unit 606 of the connection module 602 and the connection interface 504 in response to a sharing request SHA_REQ while an information sharing function is enable. The transceiver module 104 then through the antenna unit 106 broadcasts the first predetermined sharing information to a user terminal(s) within the preset region 110, such as the user terminals 112, 114 and 116, without the need of any specific connection establishment or network therebetween. Alternatively, in the view of a client side, once the information sharing device 500 receives second predetermined sharing information transmitted from one of the user terminals 112, 114 and 116, the processing module 102 then stores the received second predetermined sharing information in the storage unit 612 of the electronic apparatus 502 through the connection unit 606 of the connection module 602 and the connection interface 504.

Moreover, the power supply module 604 is coupled to the connection module 602 and is for obtaining the direct current (DC) power from the electronic device 502 through the connection module 602 and the connection interface 504, converting the DC power into an operating power VDD, and then supplying the operating power VDD to the information sharing device 500 for use.

In the present embodiment, the information sharing device 500 may further include the register 608. When the information sharing device 500 receives the Key data KEY_Data, the processing module 102 can temperately store the received Key data KEY_Data in the register 608 while waiting for the execution of the decryption process.

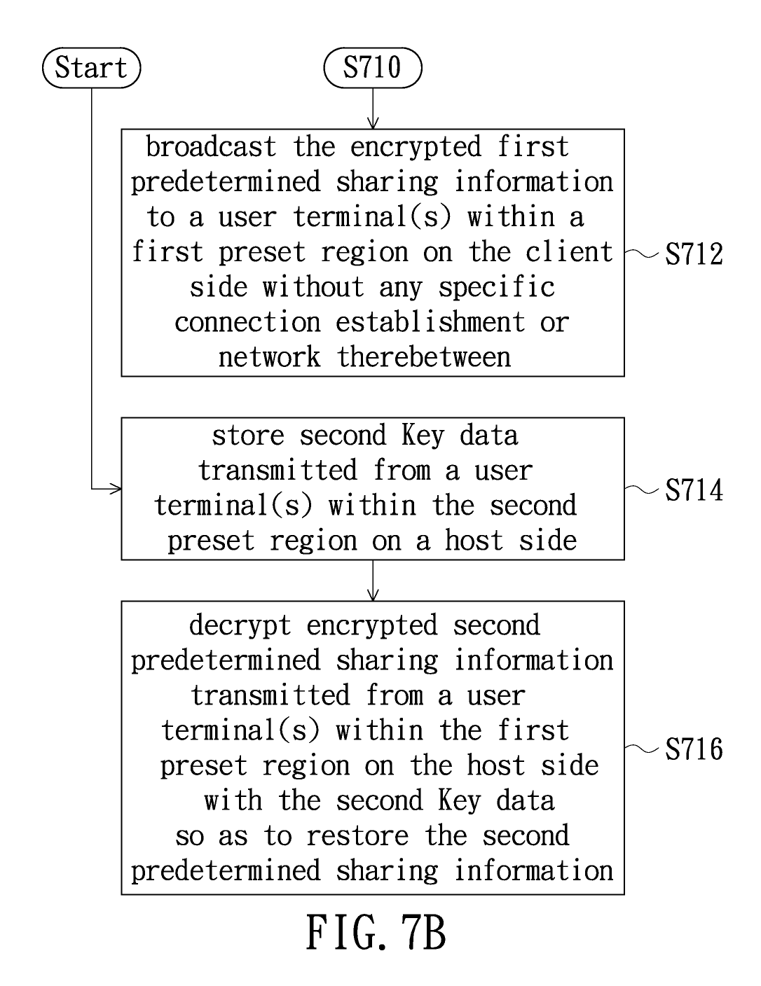

FIGS. 7A, 7B are schematic flow charts of an information sharing method in accordance with an embodiment of the present invention. As shown in FIGS. 7A, 7B and in the view of a host side, first predetermined sharing information is retrieved in response to a sharing request while an information sharing function is enable (step S708). Afterwards, the retrieved first predetermined sharing information is broadcasted to a user terminal(s) within a first preset region (step S712) without any specific connection establishment or network therebetween. Specifically, in another embodiment, the retrieved first predetermined sharing information may firstly be encrypted (step S710) before the step S712. In addition, the first predetermined sharing information is, for example, a latest shot photo or video.

Moreover, in another embodiment, first Key data is generated in response to an enablement of a Key sharing function (step S704). The first Key data is then broadcasted to a user terminal(s) within a second preset region (step S706) without the need of any specific connection establishment or network therebetween.

Alternatively, in the view of a client side, second Key data is being stored when transmitted from a user terminal within the second preset region on a host side (step S714). Encrypted second predetermined sharing information, transmitted from a user terminal within the first preset region, is decrypted by the second Key data so as to be restored back to the second predetermined sharing information (step S716).

To facilitate the convenience and security features in the present embodiment, the first preset region is designed to be larger than the second preset region; and thus, only the user terminal(s) restricted in a smaller region can have the Key data. In addition, because the first preset region, capable of receiving the predetermined sharing information, is larger than the second preset region, capable of receiving the Key data, the user terminal(s) with the Key data can have a movement liberty while receiving the predetermined sharing information.

To sum up, in the present invention the predetermined sharing information, such as a latest shot photo or video, can be broadcasted to all the user terminals within a preset region without the need of any specific connection establishment or network therebetween. In addition, according to the broadcasting manner in the present invention, the real-time one-to-many or even many-to-many information sharing can be achieved.

Moreover, through simply arranging the information sharing apparatuses within a preset region, the present invention facilitates the information sharing therebetween without the need of any specific connection establishment, network or password setting, so the implementation of information sharing according to the present invention is much simple relatively. Besides, the information sharing in the present invention can also have a security feature through firstly generating and transmitting Key to the user terminal(s) within a second preset region, encrypting the predetermined sharing information with the Key, and then broadcasting the encrypted predetermined sharing information to the user terminal(s) within a first preset region; wherein the first region is, for example, larger than the second preset region.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An information sharing method, comprising a step of:
broadcasting first predetermined sharing information to a user terminal(s) within a first preset region on a client side in response to a sharing request while an information sharing function is enable.

2. The information sharing method according to claim 1, wherein before the broadcast of the first predetermined sharing information, the information sharing method further comprises a step of:
encrypting the first predetermined sharing information.

3. The information sharing method according to claim 2, further comprising steps of:
generating first Key data when a Key sharing function is enable; and
broadcasting the first Key data to a user terminal(s) within a second preset region on the client side;
wherein the encrypted first predetermined sharing information is decrypted by the first Key data.

4. The information sharing method according to claim 3, wherein the first preset region is larger than the second preset region.

5. The information sharing method according to claim 3, further comprising steps of:
receiving second Key data from a user terminal within the second preset region on a host side and storing the second Key data in a storage space;
receiving encrypted second predetermined sharing information from a user terminal within the first preset region on the host side and decrypting the encrypted second predetermined sharing information with the second Key data; and
storing the decrypted second predetermined sharing information in the storage space.

6. The information sharing method according to claim 5, wherein the first and second predetermined sharing information each are a latest shot photo or video.

7. An information sharing module, comprising:
an antenna unit;
a transceiver module coupled to the antenna unit; and
a processing module coupled to the transceiver module for transmitting first predetermined sharing information to the transceiver module in response to a sharing request while an information sharing function is enable, and controlling the transceiver module through the antenna unit to broadcast the first predetermined sharing information to a user terminal(s) within a preset region on a client side.

8. The information sharing module according to claim 7, wherein the processing module comprises:
a retrieving module for retrieving the first predetermined sharing information in response to the sharing request;
an encryption unit for encrypting the first predetermined sharing information;
a Key generation unit for generating first Key data while a Key sharing function is enable; and
a transmission unit coupled to the encryption unit and the Key generation unit for transmitting the first Key data and the encrypted first predetermined sharing information to the transceiver module, and the transceiver module through the antenna unit broadcasting the first Key data and the encrypted first predetermined sharing information to a user terminal(s) within the preset region on the client side.

9. The information sharing module according to claim 7, wherein the processing module further comprises:
a receiving unit for receiving second Key data and encrypted second predetermined sharing information from a user terminal within the preset region on a host side; and
a decryption unit for decrypting the encrypted second predetermined sharing information with the second Key data when the encrypted second predetermined sharing information is transmitted to the receiving unit, and thereby the encrypted second predetermined sharing information is restored back to the second predetermined sharing information.

10. An information sharing device adapted to be externally installed to an electronic apparatus, the information sharing device comprising:
an antenna unit;
a transceiver module coupled to the antenna unit;
a connection module having a connection unit for coupling to the electronic apparatus; and
a processing module coupled to the transceiver module and the connection module for retrieving first predetermined sharing information from the electronic apparatus in response to a sharing request while an information sharing function is enable and then transmitting the first predetermined sharing information to the transceiver module;
wherein the transceiver module through the antenna unit broadcasts the first predetermined sharing information to a user terminal(s) within a preset region on a client side.

11. The information sharing device according to claim 10, further comprising a power supply module coupled to the connection module for receiving direct-current power from the electronic apparatus, converting the received direct-current power into operating power, and supplying the operating power to the information sharing device for use.

12. The information sharing device according to claim 10, wherein the processing module comprises:
a retrieving module coupled to the connection module for retrieving the first predetermined sharing information from the electronic apparatus through the connection module in response to the sharing request;
an encryption unit for encrypting the first predetermined sharing information;
a Key generation unit for generating first Key data while a Key sharing function is enable; and
a transmission unit coupled to the encryption unit and the Key generation unit for transmitting the first Key data and the encrypted first predetermined sharing information to the transceiver module, and the transceiver module through the antenna unit broadcasting the first Key data and the encrypted first predetermined sharing information to a user terminal(s) within the preset region on the client side.

13. The information sharing device according to claim 10, wherein the processing module further comprises:
a receiving unit for receiving second Key data and encrypted second predetermined sharing information from a user terminal within the preset region on a host side; and
a decryption unit for decrypting the encrypted second predetermined sharing information with the second Key data when the encrypted second predetermined sharing information is transmitted to the receiving unit, and thereby the encrypted second predetermined sharing information is restored back to the second predetermined sharing information.

14. An electronic product, comprising:
a control circuit for retrieving first predetermined sharing information from a storage unit thereof; and
an information sharing module coupled to the control circuit for broadcasting the retrieved first predetermined sharing information to a user terminal(s) within a preset region on a client side in response to a sharing request when an information sharing function is enable.

15. The electronic product according to claim 14, wherein the information sharing module comprises:
an antenna unit;
a transceiver module coupled to the antenna unit; and
a processing module coupled to the transceiver module and the control circuit for transmitting the first predetermined sharing information to the transceiver module and controlling the transceiver module through the antenna unit to broadcast the first predetermined sharing information to a user terminal(s) within the first preset region on the client side.

16. The electronic product according to claim 15, wherein the processing module comprises:
a retrieving module coupled to the control circuit for retrieving the first predetermined sharing information from the storage unit in response to the sharing request;
an encryption unit for encrypting the first predetermined sharing information;
a Key generation unit for generating first Key data while a Key sharing function is enable; and
a transmission unit connected to the encryption unit and the Key generation unit for transmitting the first Key data and the encrypted first predetermined sharing information to the transceiver module, and the transceiver module through the antenna unit broadcasting the first Key data and the encrypted first predetermined sharing information to a user terminal(s) within the preset region on the client side.

17. The electronic product according to claim 16, further comprising:
a Key enable unit, wherein the Key sharing function is enable when the Key enable unit is triggered.

18. The electronic product according to claim 15, wherein the processing module further comprises:
a receiving unit for receiving second Key data and encrypted second predetermined sharing information from a user terminal within the preset region on a host side; and
a decryption unit for decrypting the encrypted second predetermined sharing information with the second Key data when the encrypted second predetermined sharing information is transmitted to the receiving unit, and thereby the encrypted second predetermined sharing information is restored back to the second predetermined sharing information.

19. The electronic product according to claim 14, further comprising:
a transmission enable unit, wherein the information sharing function is enable when the transmission enable unit is triggered.
